(19) United States
(12) Patent Application Publication
(10) Pub. No.: US 2025/0320894 A1
(43) Pub. Date: Oct. 16, 2025

(54) BEARING CASSETTE

(71) Applicant: Italian Motors USA LLC, Sumas, WA (US)

(72) Inventor: Claudio Valiante, Sumas, WA (US)

(73) Assignee: Italian Motors USA LLC, Sumas, WA (US)

(21) Appl. No.: 19/070,323

(22) Filed: Mar. 4, 2025

Related U.S. Application Data
(60) Provisional application No. 63/634,153, filed on Apr. 15, 2024.

(51) Int. Cl. F16C 23/02; B60B 35/18

(52) U.S. Cl. CPC F16C 23/02; B60B 35/18; B60B 2380/90; B60B 2900/90; F16C 2326/02

(57) ABSTRACT

A bearing cassette assembly may include a cassette securable to a chassis of a vehicle, and a cam securable within the cassette in one of a plurality of radial positions relative to the cassette, wherein the cam is configured to receive a first vehicle axle bearing assembly. When the cam is moved into one of a plurality of radial positions, the first vehicle axle bearing assembly is moved relative to a second vehicle axle bearing assembly of the vehicle.

### CROSS REFERENCE TO RELATED APPLICATION

This application claims the benefit of U.S. Provisional Application No. 63/634,153, filed Apr. 15, 2024, the entire contents of which are incorporated herein by reference.

### BACKGROUND

In karting, a wheelbase of the chassis is the distance between the axis of the front and rear wheels (“wheelbase”). A longer wheelbase typically offers the advantage in fast turns because by extending the wheelbase between front and rear wheels, the chassis flexes more and generates more grip at the rear. By contrast, a shorter wheelbase provides the kart a very tight turning radius and more agility. Modification of the wheelbase is very seldomly done since most chassis have a fixed wheelbase, and the only way to change it would be to use another frame with an entirely different wheelbase measurement.

### SUMMARY

In some aspects, the techniques described herein relate to a bearing cassette assembly, including: a cassette securable to a chassis of a vehicle; and a cam securable within the cassette in one of a plurality of radial positions relative to the cassette, wherein the cam is configured to receive a first vehicle axle bearing assembly, wherein when the cam is moved into one of a plurality of radial positions, the first vehicle axle bearing assembly is moved relative to a second vehicle axle bearing assembly of the vehicle.

In some aspects, the techniques described herein relate to a method of adjusting a wheelbase for a vehicle by moving a first vehicle axle bearing assembly relative to a second vehicle axle bearing assembly of the vehicle, the method including: moving a cam into one of a plurality of radial positions relative to a cassette secured to a chassis of a vehicle, wherein the cam is secured on a first vehicle axle bearing assembly; effectuating a cam action against the first vehicle axle bearing assembly when a radial position of the cam body is changed within the cassette; and securing the cam relative to the cassette when the cam is in a preferred radial position relative to the cassette.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 shows an isometric view of a bearing cassette assembly formed in accordance with examples of the present disclosure shown in use in a kart rear axle assembly.

FIG. 2 shows an isometric view of the bearing cassette assembly of FIG. 1.

FIG. 3 shows an isometric view of a cassette of the bearing cassette assembly of FIG. 1.

FIG. 4 shows an isometric view of a cam of the bearing cassette assembly of FIG. 1.

FIG. 5 shows an isometric view of the cam of the bearing cassette assembly of FIG. 1 receiving a bearing assembly of the kart rear axle assembly.

FIG. 6 shows an isometric view of the bearing assembly of FIG. 5.

### DETAILED DESCRIPTION

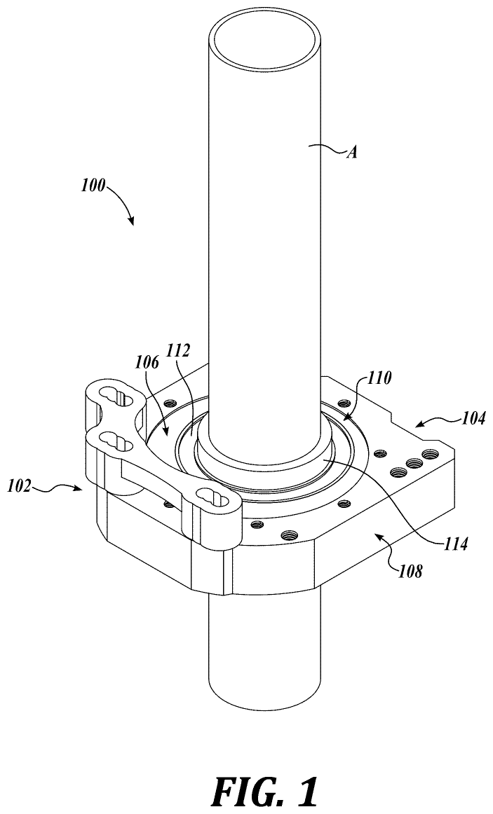

With reference to FIGS. 1-6, an example of a bearing cassette assembly 104 configured to allow a kart's wheelbase to be adjusted in just a few simple steps will now be described. The bearing cassette assembly 104 may be configured for use with a rear axle bearing assembly 102 of a kart rear axle assembly 100 having an axle A.

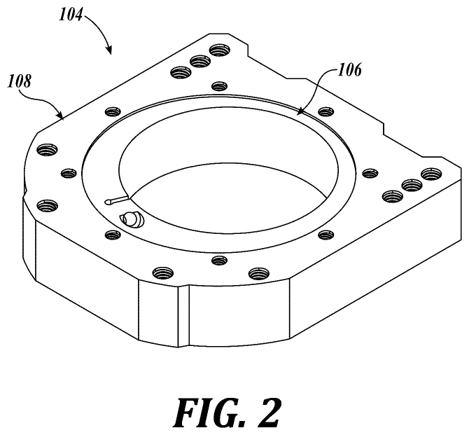

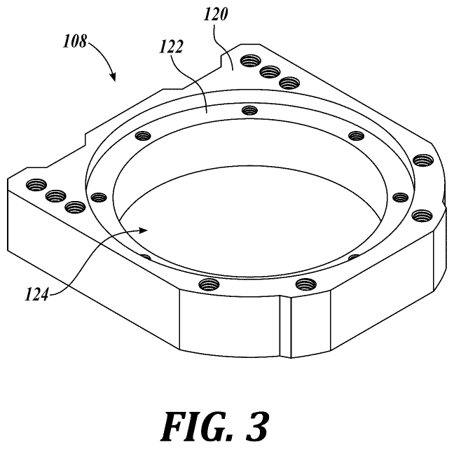

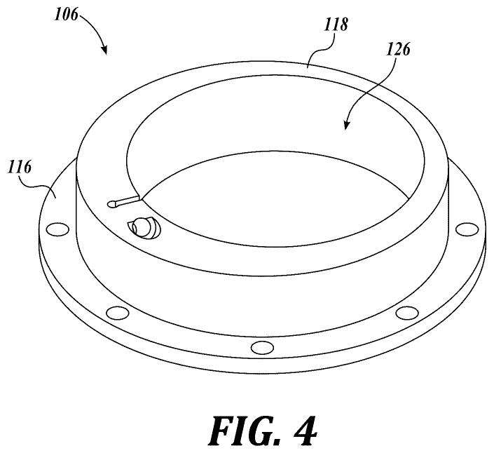

Referring to FIGS. 1 and 2, the bearing cassette assembly 104 includes a cam 106 adjustably secured within a cassette 108. As may best be seen by referring to FIG. 3, the cassette 108 includes a frame-like structure or body 120 configured to be fixedly secured relative to a kart's chassis or frame, as well as to other kart components, such as in a manner well known. For instance, the cassette 108 may be fixedly secured relative to a kart's chassis or frame in a predetermined vertical position. A cassette through-hole 124 passes through the body 120 of the cassette 108 that is sized and configured to receive a first portion of the cam 106 (shown in FIG. 4). The cassette 108 further includes a counterbore 122 surrounding the cassette through-hole 124 configured to receive a second portion of the cam 106.

As may best be seen by referring to FIG. 4, the cam 106 includes a connecting flange 116 extending circumferentially around a cam body 118. The cam body 118 has an overall shape and size to fit within the cassette through-hole 124 of the cassette 108. In that regard, an outer diameter of the cam body 118 is substantially the same shape and size as an inner diameter of the cassette through-hole 124. In this manner, loads may be transferred from the cam body 118 of the cam 106 to the body 120 of the cassette 108. At the same time, the cam body 118 is sized to rotate within the cassette through-hole 124 such that the cam 106 may be moved radially into at least two different positions relative to the cassette 108. When in a preferred position, the connecting flange 116 of the cam 106 may be secured within the counterbore 122 of the cassette 108, such as by passing a fastener(s) through corresponding holes in each.

The cam body 118 includes an eccentric cam through-hole 126 that is located off-center within the body. In other words, a center of the cam through-hole 126 is offset from a center of the cam body 118. The eccentric cam through-hole 126 allows the cam body 118 to effectuate a cam action against an outer collar or ring of the bearing assembly 110. More specifically, when the radial position of the cam body 118 is changed within the cassette 108 (which is fixed relative to the kart chassis), the longitudinal position of the bearing assembly 110 (and therefore the axle A) is shifted forwardly or rearwardly relative to the front axle. By moving the bearing assembly 110 forwardly or rearwardly relative to the front axle, a correspondingly smaller or larger wheelbase may be used.

When the radial position of the cam body 118 is changed within the cassette 108 (which is fixed relative to the kart chassis), the vertical location of the bearing assembly 110 (and therefore the axle A) is also necessarily shifted up or down relative to the front axle. By moving the bearing assembly 110 up or down relative to the front axle, a correspondingly smaller or larger rear ride height may be used. In some examples, adjusting the radial position of the cam body 118 within the cassette 108 does not change the vertical location of the bearing assembly 110 (and therefore the axle A).

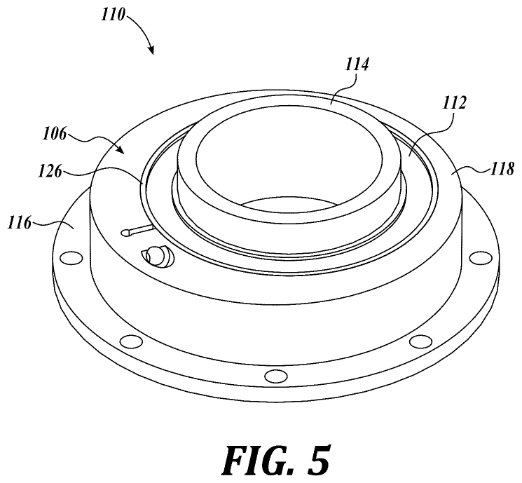

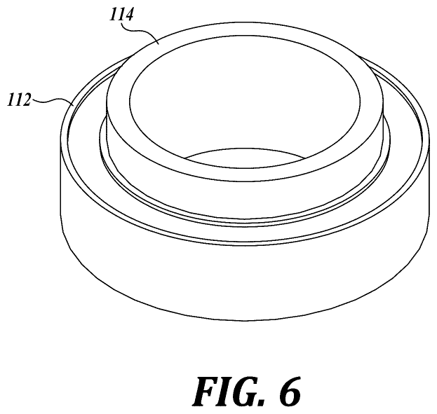

An exemplary bearing assembly 110 is shown in FIG. 6, wherein the bearing assembly 110 includes an outer collar or bearing ring 112 and an inner collar or bearing ring 114. The outer bearing ring 112 is sized to be received within the eccentric cam through-hole 126 of the cam 106. Referring to FIG. 5, the cam 106 may be fixedly secured to the outer bearing ring 112 with a clamping fastener assembly or the like. The inner bearing ring 114 is received within the outer bearing ring 112 and includes an axle through-hole (not labeled) sized to receive the axle A. It should be appreciated that any suitable bearing assembly may be used.

The cam 106 and cassette 108 may be made from any suitable material to facilitate moving the cam 106 into a radial position relative to the cassette 108 and to withstand the loads of the kart when fixed in position. For instance, aluminum may be used.

The bearing cassette assembly 104 may be used to move the rear axle A forwardly or rearwardly (and up and down) relative to a front axle, thereby allowing a kart's wheelbase (and rear ride height) to be adjusted in just a few simple steps. For instance, when the cam 106 is moved into one of a plurality of radial positions relative to the cassette 108, the first vehicle axle bearing assembly 110 is moved relative to a second vehicle axle bearing assembly (e.g., an axle bearing assembly for a wheel of a front axle assembly).

Although the bearing cassette assembly 104 is described with reference to a kart, it should be appreciated that the bearing cassette assembly 104 may be used with any suitable vehicle.

A non-limiting example of a method of adjusting a wheelbase for a vehicle by moving a first vehicle axle bearing assembly relative to a second vehicle axle bearing assembly of the vehicle may include moving a cam into one of a plurality of radial positions relative to a cassette secured to a chassis of a vehicle, wherein the cam is secured on a first vehicle axle bearing assembly. The method may be carried out using any components described herein with reference to the bearing cassette assembly 104, or any other suitable components. For ease of description, aspects of the method may be described with reference to the bearing cassette assembly 104.

In that regard, the method of adjusting a wheelbase for a vehicle by moving a first vehicle axle bearing assembly relative to a second vehicle axle bearing assembly of the vehicle may include moving cam 106 into one of a plurality of radial positions relative to the cassette 108 secured to a chassis of a vehicle. The cam 106 is secured on a first vehicle axle bearing assembly, such as kart rear axle assembly 100.

The method may further include effectuating a cam action against the first vehicle axle bearing assembly when a radial position of the cam body is changed within the cassette. For instance, when the radial position of the cam body of cam 106 is changed relative to the cassette 108, the cam 106 effectuates a cam action against the kart rear axle assembly 100. In that regard, the kart rear axle assembly 100 can be shifted forwardly or rearwardly relative to a second or front kart axle assembly. In some examples, the kart rear axle assembly 100 can be shifted up or down relative to a second or front kart axle assembly.

The method may further include securing the cam 106 relative to the cassette 108 when the cam is in a preferred radial position relative to the cassette. In that manner, the vehicle or kart may then be ready for use with an adjusted wheelbase.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Language such as “front”, “rear”, “top”, “bottom”, “upper”, “lower”, “vertical”, “horizontal”, “lateral”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, it may not be included or may be combined with other features.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Likewise, the disclosure is not limited to various examples given in this specification. Unless otherwise defined, technical and scientific terms used herein have the meaning as commonly understood by one of ordinary skill in the art to which this disclosure pertains. In the case of conflict, the present document, including definitions will control.

Note that titles or subtitles may be used in the examples for convenience of a reader, which in no way should limit the scope of the disclosure.

While illustrative examples have been illustrated and described, it will be appreciated that various changes can be made therein without departing from the spirit and scope of the invention.

The examples of the invention in which an exclusive property or privilege is claimed are defined as follows:

1. A bearing cassette assembly, comprising:
a cassette securable to a chassis of a vehicle; and
a cam securable within the cassette in one of a plurality of radial positions relative to the cassette, wherein the cam is configured to receive a first vehicle axle bearing assembly, wherein when the cam is moved into one of a plurality of radial positions, the first vehicle axle bearing assembly is moved relative to a second vehicle axle bearing assembly of the vehicle.

2. The bearing cassette assembly of claim 1, wherein the cassette comprises:
a body;
a cassette through-hole passing through the body that is sized and configured to receive a first portion of the cam;
a counterbore surrounding the cassette through-hole configured to receive a second portion of the cam.

3. The bearing cassette assembly of claim 2, wherein the cam includes a connecting flange extending circumferentially around a cam body, wherein the cam body defines the first portion of the cam and the connecting flange defines the second portion of the cam.

4. The bearing cassette assembly of claim 3, wherein an outer diameter of the cam body is substantially a same shape and size as an inner diameter of the cassette through-hole.

5. The bearing cassette assembly of claim 4, wherein an interface between the cam body and the body of the cassette is configured such that loads may be transferred from the cam body to the body of the cassette.

6. The bearing cassette assembly of claim 5, wherein the cam body of the cam is sized to rotate within the cassette through-hole such that the cam may be moved radially into at least two different positions relative to the cassette.

7. The bearing cassette assembly of claim 6, wherein the connecting flange is securable within the counterbore of the cassette when the cam is in a preferred radial position relative to the cassette.

8. The bearing cassette assembly of claim 3, wherein the cam body includes an eccentric cam through-hole that is located off-center within the cam body.

9. The bearing cassette assembly of claim 8, wherein the cam body effectuates a cam action against the first vehicle axle bearing assembly when a radial position of the cam body is changed within the cassette.

10. The bearing cassette assembly of claim 9, wherein the cam action against the first vehicle axle bearing assembly causes at least one of a longitudinal and vertical position of the first vehicle axle bearing assembly to shift forwardly or rearwardly or up or down relative to the second vehicle axle bearing assembly.

11. The bearing cassette assembly of claim 1, wherein an interface between the cam and the cassette is configured such that loads may be transferred from the cam to the cassette.

12. The bearing cassette assembly of claim 11, wherein a cam body of the cam is sized to rotate within a cassette through-hole such that the cam may be moved radially into at least two different positions relative to the cassette.

13. A method of adjusting a wheelbase for a vehicle by moving a first vehicle axle bearing assembly relative to a second vehicle axle bearing assembly of the vehicle, the method comprising:
moving a cam into one of a plurality of radial positions relative to a cassette secured to a chassis of a vehicle, wherein the cam is secured on a first vehicle axle bearing assembly;
effectuating a cam action against the first vehicle axle bearing assembly when a radial position of the cam is changed within the cassette; and
securing the cam relative to the cassette when the cam is in a preferred radial position relative to the cassette.

14. The method of claim 13, further comprising:
securing a first portion of the cam within a cassette through-hole passing through a body of the cassette; and
securing a second portion of the cam within a counterbore surrounding the cassette through-hole.

15. The method of claim 13, further comprising:
securing a body of the cam within a cassette through-hole passing through a body of the cassette; and
securing a connecting flange of the cam within a counterbore surrounding the cassette through-hole, the connecting flange extending circumferentially around the cam body.

16. The method of claim 15, further comprising rotating the cam body within the cassette through-hole such that the cam may be moved radially into at least two different positions relative to the cassette.

17. The method of claim 16, further comprising securing the connecting flange within the counterbore of the cassette when the cam is in a preferred radial position relative to the cassette.

18. The method of claim 13, further comprising transferring loads from the cam body to the body of the cassette.

19. The method of claim 13, further comprising shifting a longitudinal or vertical position of the first vehicle axle bearing assembly at least one of forwardly or rearwardly and up or down relative to the second vehicle axle bearing assembly when moving the cam into one of a plurality of radial positions relative to the cassette.
